(19) United States
(12) Patent Application Publication
(10) Pub. No.: US 2013/0078380 A1
(43) Pub. Date: Mar. 28, 2013

(54) METHOD OF UNDERCOATING A SUSPENSION AND UNDERCARRIAGE AREA

(71) Applicant: Great Dane Limited Partnership, Chicago, IL (US)

(72) Inventors: Chris Stolfe, Savannah, GA (US); Matthew Gunzburger, Savannah, GA (US)

(73) Assignee: GREAT DANE LIMITED PARTNERSHIP, Chicago, IL (US)

(21) Appl. No.: 13/681,076

(22) Filed: Nov. 19, 2012

Related U.S. Application Data
(63) Continuation of application No. 12/141,350, filed on Jun. 18, 2008.
(60) Provisional application No. 60/970,113, filed on Sep. 5, 2007.

(51) Int. Cl. B62D 21/00

(52) U.S. Cl. CPC B62D 21/00
USPC 427/327; 427/409; 427/410

(57) ABSTRACT

A method of coating an undercarriage of a cargo carrying vehicle, the method comprising the steps of applying primer to at least a portion of the suspension or the undercarriage, wherein the primer is either epoxy, alkyd or modified alkyd, and applying polyurea/polyurethane blend to at least a portion of the primer.

### PRIORITY

This application is a continuation of U.S. patent application Ser. No. 12/141,350, filed Jun. 18, 2008, which claims priority to U.S. Provisional Application Ser. No. 60/970,113, filed Sep. 5, 2007, the disclosures of which are incorporated herein by reference.

### BACKGROUND

The subject application relates to a method for undercoating vehicles and particularly cargo carrying vehicles, such as parts of trailers.

Cargo carrying vehicles, including straight trucks and semi-trailer trucks, have utility for transporting various materials and objects. Axles of a straight truck are attached to a single frame. A semi-trailer includes a plurality of frames releasably coupled together. Cargo carrying vehicles may carry the various materials and objects in either trailers or containers.

Trailers, including flatbed type trailers, containers, chassis and other similar cargo containers are frequently made of metal components such as steel or aluminum. Steel and aluminum are strong and relatively cost effective, however, are subject to damage from corrosion. Frequently the structural elements of cargo carrying vehicles are made of steel components including cargo carrying vehicle underbodies or undercarriages. Cargo carrying vehicle undercarriages are subject to extreme conditions. Moisture, severe temperatures, road debris, winter road traction and deicing materials can attack cargo carrying vehicle undercarriages. Structural elements left exposed to the extreme conditions, dirt and road debris accumulation may result in persistent deterioration and oxidation.

Cargo carrying vehicles are frequently provided with a protective coating to protect against extreme conditions, corrosion, etc. However, protective coatings can be breached. Surfaces of the protective coatings may be hit with roadway debris. Stones may chip off pieces of the protective coating. Other possible sorts of roadway debris may also come into contact with the protective coating and damage it or remove it. The protective coating may also be breached through physical contact of the cargo carrying vehicle with other objects. For example, the rear frame structure and rear bumper of the cargo carrying vehicle may contact the dock and potentially cause damage to the protective coating. If the coating is not maintained or repaired, the result may be persistent deterioration and oxidation of the structural elements of the cargo carrying vehicle.

Many types of undercoating have been applied to cargo carrying vehicles. Typical automotive paint may be used for protective coating. Wax-based, paint-based, and asphalt based products have been directly applied to the metal surface of cargo carrying vehicles.

### SUMMARY

The present disclosure also includes a method of coating an undercarriage of a cargo carrying vehicle, the method comprising the steps of applying a primer to a surface of the undercarriage; and applying a coating to a surface of the primer, wherein the coating includes a blend of polyurea and polyurethane.

The present disclosure also includes a method of coating a cargo carrying vehicle portion for use with a cargo carrying vehicle, the method comprising the steps of applying a primer to a metal surface of the cargo carrying vehicle portion; and applying a coating to a surface of the primer, wherein the coating includes a blend of polyurea and polyurethane.

The present disclosure also includes a cargo carrying vehicle portion for use with a cargo carrying vehicle, the cargo carrying vehicle portion comprising a frame portion comprised of metal, the frame portion including a metal surface, a primer applied to the metal surface, a coating applied to the primer, wherein the coating includes a blend of polyurea and polyurethane

### BRIEF DESCRIPTION OF THE DRAWINGS

The above-mentioned and other features of this invention, and the manner of attaining them, will become more apparent and the invention itself will be better understood by reference to the following description of embodiments of the invention taken in conjunction with the accompanying drawings, wherein:

FIG. 1 is a side elevation view of a cargo carrying vehicle and chassis that may be attached to a tractor for transport over a highway;

FIG. 2 is a top view of the chassis of FIG. 1;

FIG. 3 is a perspective view of retractable legs of the cargo carrying vehicle of FIG. 1;

FIG. 4 is a perspective view of a wheel assembly of the cargo carrying vehicle of FIG. 1;

FIG. 5 is a cross sectional view of the chassis of FIG. 5 taken along line A-A; and

FIG. 6 is a cross sectional view of the chassis of FIG. 5 taken along line A¹-A¹.

Corresponding reference characters indicate corresponding parts throughout the several views. Although the drawings represent embodiments of the present invention, the drawings are not necessarily to scale and certain features may be exaggerated in order to better illustrate and explain the present invention.

### DETAILED DESCRIPTION OF THE EXEMPLARY EMBODIMENTS

The embodiments disclosed below are not intended to be exhaustive or limit the invention to the precise forms disclosed in the following detailed description. Rather, the embodiments are chosen and described so that others skilled in the art may utilize their teachings.

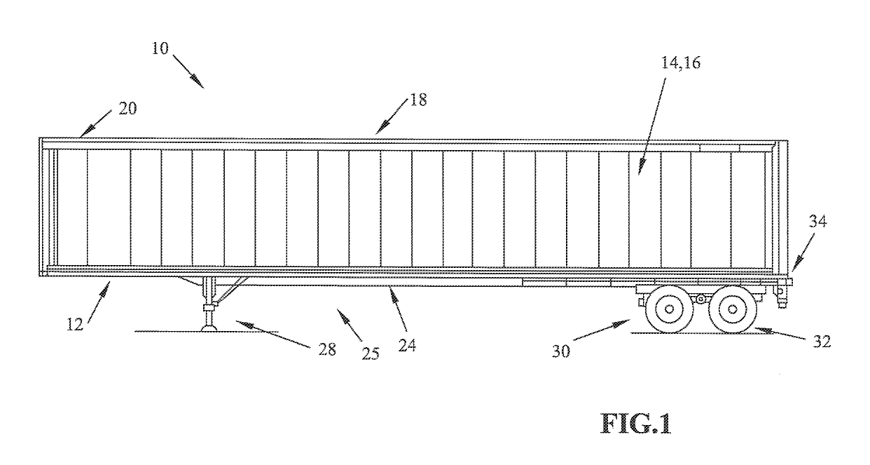

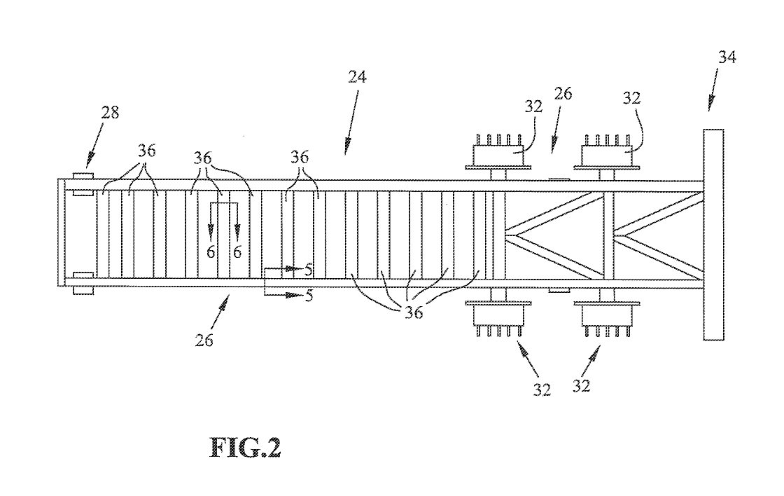

FIG. 1 illustrates cargo container 10 having floor 12, two side walls 14 and 16 and roof 18. Each side wall is identically constructed. Two top beams 20 attach roof 18 to side walls 14 and 16, respectively, and two bottom beams 22 connect floor 12 to side walls 14 and 16. Once assembled, roof 18, floor 12 and side walls 14 and 16 form container 10 having a generally rectangular shape. The assembled container's side walls, forward wall, rear doors and roof wall define an interior cargo area. The distance between opposing inner surfaces of side walls 14 and 16 is generally greater than ninety inches, and the distance between outer surfaces of the opposing side walls 14 and 16 is generally less than 110 inches. Top and bottom beams 20 and 22 may be formed of extruded aluminum or other metal or suitable material. Floor 12 may be attached to cross members 36 (FIG. 2) extending transversely between opposing bottom beams 22.

Container 10 rests on chassis 24. Floor 12 is supported at the rear by wheel assembly 30 and at the front by retractable legs 28. Wheel assembly 30 comprises a suspension system, and typically up to eight axled wheels 32 supported by axles. Wheels 32 support the container's rearward end and facilitate the container's movement when container 10 is coupled to a semi tractor (not shown). Chassis 24 and floor 12 are generally referred to as parts of undercarriage 25.

As should be well understood in this art, a trailer has an integral chassis 24 and wheel assembly 30, and does not have frames that are configured to permit the lifting and stacking of the container, as should be understood in this art. Trailers are pulled behind tractors (not shown) while container 10 are carried on chassis 24. In other words, as should be well understood in this art, container 10 includes a box that is placed on and removably attached to chassis 24, as shown in FIG. 1. Container 10 also includes trailers.

FIG. 2 illustrates chassis 24 as a longitudinal I-beam type including longitudinal beams 26 extending between retractable legs 28 and wheel assembly 30 including a plurality of axled wheels 32. Chassis 24 also includes bumper 34 or rear bolster 34. As previously described, chassis 24 is configured to support container 10. Chassis 24 may also include cross members 36 extending between longitudinal beams 26. Longitudinal beams 26 and cross members 36 may take many shapes such as I-shaped, T-shaped, C-shaped, or O-shaped when viewed in a cross sectional perspective such as A-A or A¹-A¹. Chassis 24 may be formed from any suitable material such as extruded aluminum.

It should be understood for this disclosure that the cargo container undercarriage 25 includes floor 12, chassis 24, or chassis component including wheel assembly 30, retractable legs 28, bumper 34, or rear frame of container 10, as well as any other kind of chassis. In one embodiment, undercarriage 25 includes the frame or chassis 24 of a flatbed trailer. In another embodiment, the frame of a flatbed trailer is coated. In yet another embodiment, the entire frame of a flatbed trailer is encapsulated.

One of skill in the art will recognize that undercarriage components can be coated under various conditions including prior to assembly, during assembly, or disassembled for coating. Furthermore, any undercarriage component may be coated in accordance with this disclosure.

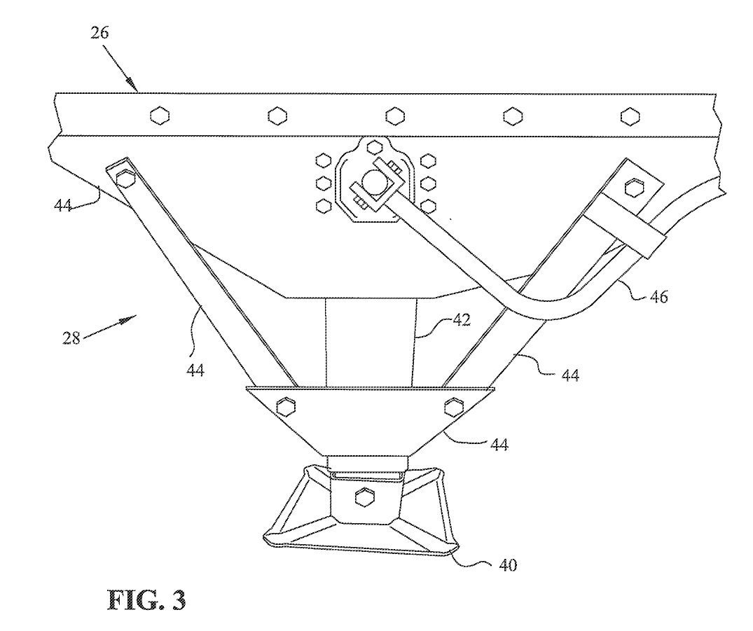

As shown in FIG. 3, retractable leg 28 is illustrated. Retractable leg 28 is illustrated as separate from the rest of cargo container 10. As understood by one of ordinary skill in the art, retractable leg 28 also illustrates a pair of retractable legs 28 separated from the rest of chassis 24. As illustrated in FIG. 3, retractable leg 28 signifies a component of undercarriage 25.

Retractable leg 28 includes platform 40 coupled to extension system 42 including support portions 44 possibly coupled to longitudinal beam 26. As shown in FIG. 3, retractable leg 28 is shown including shaft 46 (in dashed lines). Shaft 46 is removably coupled to the rest of retractable leg 28. In an exemplary embodiment, shaft 46 is removed prior to coating. In another exemplary embodiment, retractable leg 28 is coated prior to the assembly of shaft 46 to the rest of retractable leg 28. In yet another exemplary embodiment, shaft 46 is coated along with the rest of retractable leg 28. In another exemplary embodiment, select components of retractable leg 28, such as at least one of platform 40, extension system 42, or support portions 44, are coated.

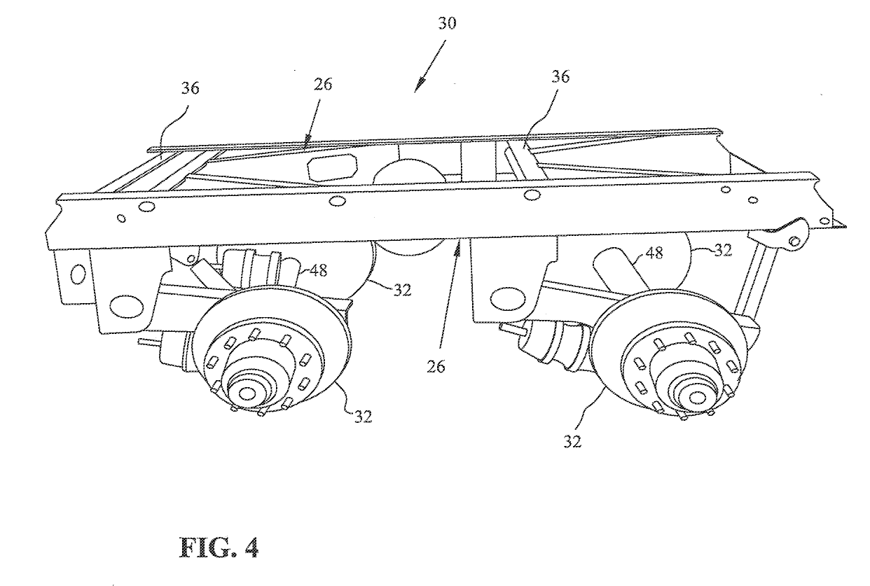

As shown in FIG. 4, wheel assembly 30 is illustrated as separated from the rest of cargo container 10. As illustrated in FIG. 4, wheel assembly 30 signifies a component of undercarriage 25. Wheel assembly 30 includes longitudinal beams 26, cross members 36, and a plurality of axled wheels 32. Similar to shaft 46 (FIG. 3), wheels 32 may be covered, removed, or not yet assembled to the rest of wheel assembly 30 when wheel assembly 30 is coated. In an exemplary embodiment, axles 48 are coated. In another exemplary embodiment, select components of wheel assembly 30, such as the suspension, are coated.

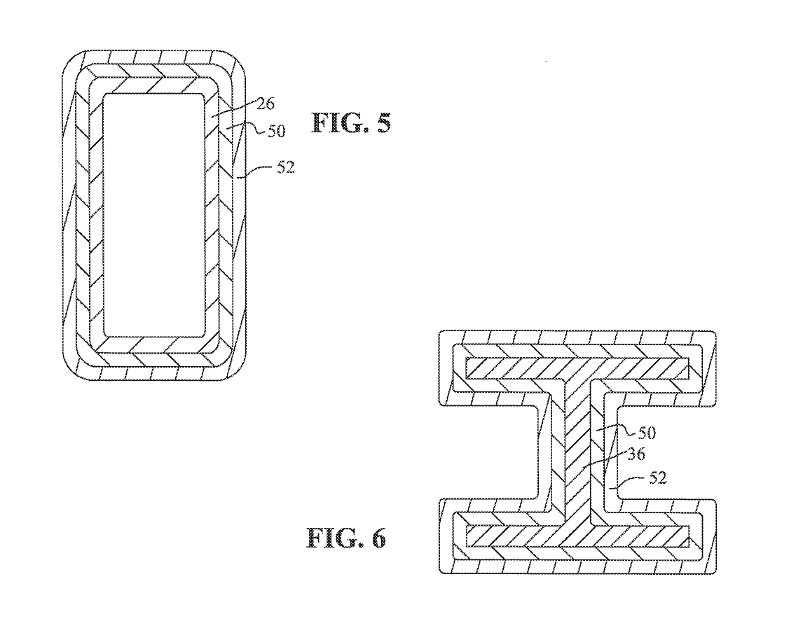

A cross section of an exemplary embodiment of longitudinal beam 26 is shown in FIG. 5. Longitudinal beam 26 is illustrated as rectangular. As previously described, one of ordinary skill in the art would know that longitudinal beam 26 can come in a variety of different shapes, sizes, or configurations. The coated beam 26 is shown as encapsulated by primer 50. In an exemplary embodiment, primer 50 encapsulates longitudinal beam 26 such that there are substantially no exterior surfaces of longitudinal beam 26 not coated with primer 50. Metal surfaces of undercarriage 25 or components of undercarriage 25, such as longitudinal beam 26, are coated with primer 50. For example primer 50 is applied to the metal surfaces by use of a proportioning system such as typical spray equipment.

The coating of the present disclosure comprises a two-part system, primer 50 and blend 52. Plural component proportioning systems can be used to properly mix and apply primer 50 and/or blend 52. High temperature and/or high pressure may be used to ensure optimal coating. The proportioning system may include a reactor proportioner, hoses, guns, and supply processing equipment. For example, there are several products that may be used for the proportioning system. An exemplary proportioning system is commercially available as H-25 and H-XP2 Plural-Component Proportioners, available from Graco Inc., P.O. Box 1441, Minneapolis, Minn. 55440-1441. The proportioning system may include a commercially available plural-component spray guns such as Fusion® Air-Purge, available from Graco Inc., P.O. Box 1441, Minneapolis, Minn. 55440-1441.

Primer 50 may include either an epoxy, an alkyd or modified alkyd composition. Primer 50 is characterized by minimum strength level as evidenced by peel and tensile performance and/or test values. Primer 50 may include components to modify the properties of the end product. For example, primer 50 may include nonreactive additives such as fillers, pigments, stabilizers, plasticizers, organic tackifiers, antioxidants, compatibilizers and the like. Primer 50 provides improved corrosion protection. An exemplary epoxy is commercially available called VALGARD 130, available from Valspar Corporation, 1101 Third Street South, Minneapolis, Minn. 55415. An exemplary alkyd is commercially available called DURASPAR 130, also available from Valspar Corporation, 1101 Third Street South, Minneapolis, Minn. 55415.

As also illustrated in FIG. 5, blend 52 is shown to cover primer 50. As shown in FIG. 5, blend 52 encapsulates longitudinal beam 26 such that there are substantially no exterior surfaces of primer 50 not coated with blend 52. Blend 52 includes a polyurethane and a polyurea, such as in a two-component system. A polyurethane is generated from the reaction of an isocyanate group with a hydroxyl group (also known as an alcohol). A polyurea is generated from the reaction of an isocyanate with an amine group. Blend 52 provides a durable chemical-resistant cover that resists road debris, abrasion and road deicing materials, moisture, severe temperature, and winter road traction. Current road deicing materials include sodium chloride, magnesium chloride and calcium chloride.

In a exemplary embodiment, component A of blend 52 is an isocyanate such as diphenylmethane diisocyanate. Diphenylmethane diisocyanate may also comprise a prepolymer product. One of skill in the art would appreciate that many different isocyanates, alcohols, and amines could be used depending upon the particular application. Blend 52 may also include components to modify the properties of the end product. For example, blend 52 may include nonreactive additives such as fillers, pigments, stabilizers, plasticizers, organic tackifiers, antioxidants, compatibilizers and the like. An exemplary embodiment is GatorHyde CG Component A, available from Elastomer Specialties, Inc., 2210 South Highway 69, Wagoner, Okla. 74467. In an exemplary embodiment, component B of blend 52 may be a combination of a hydroxyl group, such as polyether polyol, and an amine such as Diethyltoluenediamine An exemplary embodiment is GatorHyde CG Component B, available from Elastomer Specialties, Inc., 2210 South Highway 69, Wagoner, Okla. 74467.

An exemplary blend is commercially available as a two component system called CORROGUARD, available from Great Dane, P.O. Box 67, 602 East Lathrop Avenue (31415), Savannah, Ga. 31402-0067. The exemplary blend may be applied in a 0.020-0.050 inches (20-50 mil) thick layer. In one embodiment, the exemplary blend may be applied in a 0.025-0.040 inches (25-40 mil) thick layer. Combining component A and component B creates a coating including polyurethane/polyurea blend 52. An exemplary embodiment of blend 52 may comprise a substantially 1:1 mixture of component A and component B.

As also illustrated in FIG. 6, blend 52 is shown to cover primer 50. As shown in FIG. 6, blend 52 encapsulates primer 50 such that there are substantially no exterior surfaces of primer 50 not coated with blend 52. The coating, including primer 50 and blend 52, may be applied to undercarriage 25 or a component of undercarriage 25 with the following optional steps. Optional steps may occur prior to primer 50 coating, such as preparation of the metal surfaces of undercarriage 25 or a component of undercarriage 25. Preparation of the metal surfaces may include several methods appreciated by one of skill in the art including sand blasting or cleaning. Other optional steps include covering or removing undercarriage components, optionally such as shaft 46 or wheels 32, that are not to be coated or coating components of the undercarriage prior to assembly.

Other optional steps may occur between coating primer 50 and coating the undercarriage with blend 52 such as allowing for drying time. Other optional steps may include transporting components for further assembly and/or processing.

In an exemplary embodiment, blend 52 is applied to primer 50 by use of a plural component proportioning system. In an exemplary embodiment, metal components are fully encapsulated by the coating including primer 50 and blend 52. In this exemplary embodiment, coating components mix under high temperature and pressure where the polymerization reaction takes place. After application, blend 52 may be dry to the touch within seconds and may reach operational cure within a short period of time, such as two minutes.

The coating may allow for application at temperatures as low as 34.degree. Fahrenheit and as high as 110° Fahrenheit. Furthermore the coating may have a large operating temperature range, such as −40° F. to +450° F. Blend 52 may be nonmoisture reactive allowing for elevated humidity and at dew points above condensing levels. The coating may have a minimum pull off adhesion value of 650 pounds per square inch (PSI) when tested under ASTM D-4541. The coating may also provide improved results when tested under ASTM B-117, D-3170, and D-1781. For example the coating may have an average peel of 26 in-lbs/in (inch-pounds per inch).

The coating may provide improved undercoating protection. The coating may provide improved hardness, elongation and adhesion. For example the coating under 275% elongation may remain pliable and withstand prolonged ultraviolet exposure.

While this invention has been described as having an exemplary design, the present invention may be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains.

What is claimed is:

1. A method of coating an undercarriage of a cargo carrying vehicle, the method comprising the steps of:
applying a primer to a surface of the undercarriage; and
applying a coating to a surface of the primer, the coating including a blend of polyurea and polyurethane,
wherein the minimum pull off adhesion value of the coating is 650 pounds per square inch.

2. The method of claim 1 wherein the primer is an epoxy.

3. The method of claim 1 wherein the coating is applied to a layer of the primer.

4. The method of claim 1 wherein the primer is applied to bare metal of the undercarriage.

5. The method of claim 4 wherein the bare metal is prepared for priming.

6. The method of claim 1 wherein the coating is applied in a layer that is 20 mils to 50 mils in thickness.

7. The method of claim 1 wherein the coating has an average peel strength of at least 26 inch-pounds per inch.
